(19) United States
(12) Patent Application Publication
(10) Pub. No.: US 2002/0066094 A1
(43) Pub. Date: May 30, 2002

(54) System and method for distributing software

(76) Inventor: Michio Futakuchi, Tokyo (JP)

Correspondence Address: LEYDIG VOIT & MAYER, LTD, 700 THIRTEENTH ST. NW, SUITE 300, WASHINGTON, DC, 20005-3960, US

(21) Appl. No.: 09/729,771

(22) Filed: Dec. 6, 2000

(30) Foreign Application Priority Data
Jul. 18, 2000 (JP) 2000-217067

(51) Int. Cl. G06F 9/445

(52) U.S. Cl. 717/172; 717/177

(57) ABSTRACT

In a software distribution system and a method of distributing software which utilizes a network such as the Internet, software, which is divided into unit programs, is transmitted and distributed through a network, and at least one unit program is distributed recorded in a recording medium.

### FIELD OF THE INVENTION

The present invention relates to a system and method for distributing software(s) using a network.

### BACKGROUND OF THE INVENTION

Conventionally, upon distributing software such as game software referred to as TV games or computer games and word processor software or spreadsheet software, a program for executing the software is recorded in a recording medium such as a cassette case, a floppy disk or a CD-ROM, and this has been distributed widely among people. However, this software distribution method using these recording media has problems of illegal copying and unlicensed used software sales, and there have been increasing demands for effective measures to prevent these activities.

Moreover, in conventional software so-called shareware, there has been a method in which, after a program which is operable only in a limited function is first distributed for free, and only if the payment is confirmed, a keyword for making the distributed program completely operable is sent to the user. However, even in this case, since only a single key word is set for each of the programs, it becomes difficult to prevent illegal copies, etc. of the program when the user leaks the keyword to other people, or publishes the keyword.

### SUMMARY OF THE INVENTION

It is an object of this invention to provide a software distribution system and a software distribution method for preventing illegal copying and unlicensed used software sales.

According to the software distribution system and method of this invention, software(s) divided into a plurality of unit programs are stored into a database. This database is connected to a supplier server and this supplier server is connected to a network such as the Internet. The supplier server receives order information transmitted from a terminal device also connected to the network. The supplier server checks the authenticity of the order information. When the order information is authentic, the supplier server selects a unit program out of the unit programs stored in the database and send the selected unit program to terminal device that has sent the order information through the network. A part or all of the remaining unit programs of a particular software are stored in a recording medium. This recording medium is the distributed to an executor of the software. Thus, a part of the software is supplied through the network after checking the authenticity of the order information send by the user and the remaining part of the software is supplied in the form of the recording medium. Accordingly, it is possible to prevent illegal copying of software and unlicensed used software sales.

Other objects and features of this invention will become apparent from the following description with reference to the accompanying drawings.

### BRIEF DESCRIPTION OF THE DRAWINGS

FIG. 1 is a drawing that shows an arrangement of a software distribution system in accordance with a first embodiment of the present invention.

FIG. 2 is a flow chart that shows a software distribution method in accordance with the first embodiment.

FIG. 3 is a flow chart that shows a software distribution method in accordance with a second embodiment.

FIG. 4 is a flow chart that shows a software distribution method in accordance with a third embodiment.

FIG. 5 is a drawing that shows an arrangement of a software distribution system in accordance with the third embodiment of the present invention.

### DESCRIPTION OF THE PREFERRED EMBODIMENTS

First, a first embodiment of the present invention will be detailed here.

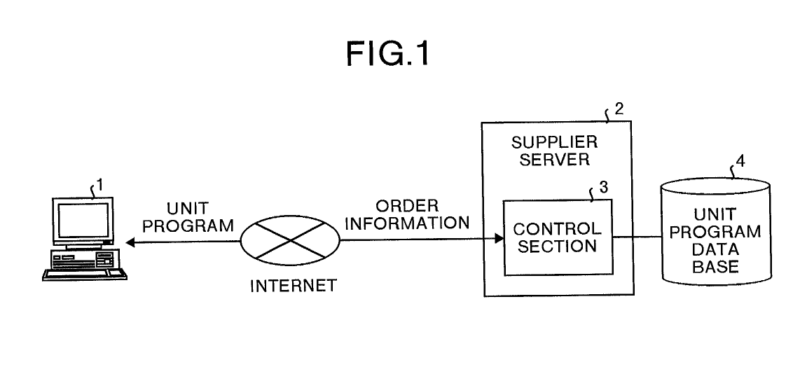

FIG. 1 shows an arrangement of a software distribution system of the present invention. Legend 1 denotes a terminal device, and legend 2 denotes a supplier server which is installed on the side that supplies a software. The supplier server 1 is connected to the terminal device 1 through a network such as the Internet. Legend 3 denotes a control section in the supplier server 2, and legend 4 denotes a unit program database connected to the supplier server.

Next, a detailed explanation of the functions of each components in the software distribution system of FIG. 1 will be given.

A supplier of software divides the software, which software is to be distributed to many unidentified software executors, into a plurality of unit programs. Various methods may be considered for dividing the program constituting the software. For example, the program may be divided into an initial smaller portion and a succeeding bigger portion, or an initial bigger portion and a succeeding smaller portion, or virtually uniform portions. Any method for dividing a program and the programs divided in this manner may be used as long as a series of software is divided into a plurality of portions in such a manner that the sole application of each of individual unit programs fails to function as the software, that is, fails to form complete software even upon operation on a personal computer or an exclusively-used apparatus.

Moreover, the program here means a sequence of command sets that have been designed so as to carry out a desired operation when used in a CPU (Central Processing Unit), an MPU (Micro Processor Unit), a DSP (Digital Signal Processor), etc., and it includes not only software such as game software and word processor software, but also programs for reproducing so-called digital contents such as animations and music programs that have been digitized.

Next, a software executor (a person who receives the software and executes it) obtains a unit program corresponding to the initial portion of the divided software from the supplier of the software. The software may be downloaded from the software supplier to the terminal device 1 of the software executor through the network, such as the Internet, or may be supplied from the software supplier on a recording medium, such as CD-ROM, etc.

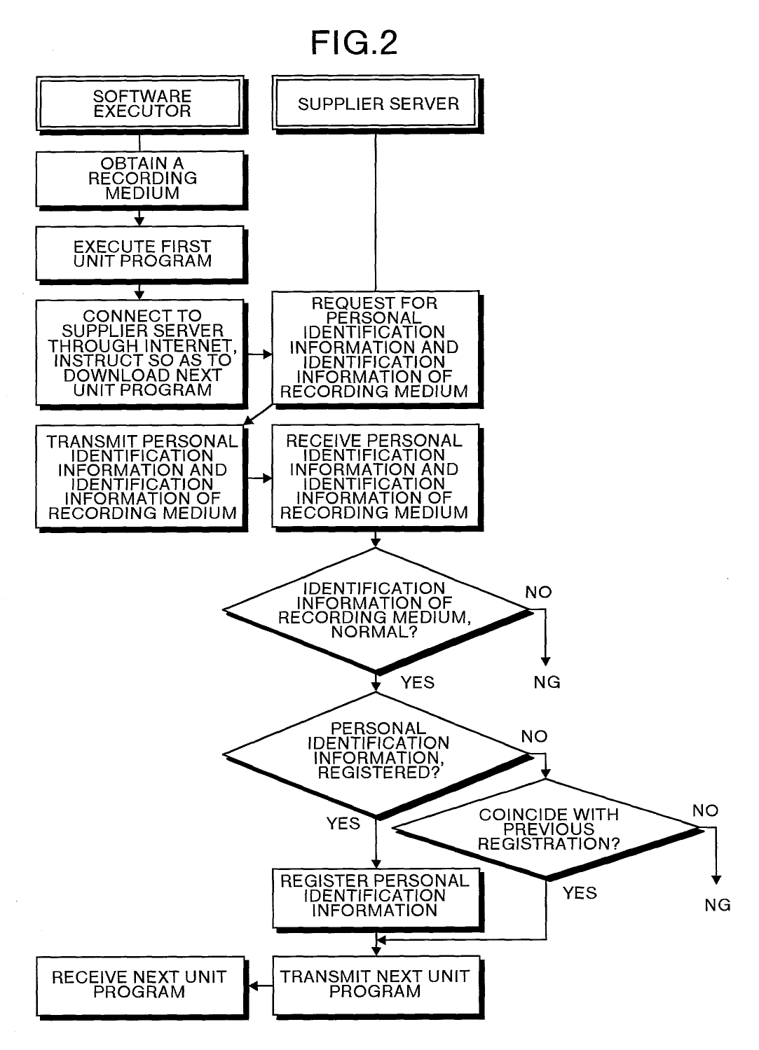

Referring to FIG. 2, the first embodiment exemplifies a case in which the software executor obtains a first unit program by purchasing a recording medium such as a CD-ROM.

First, the software executor prepares a terminal device 1 which is connectable to the Internet. This terminal device 1 may be a personal computer, a game dedicated device or a set top box, as long as it enables read/write operations of the program.

The software executor subsequently obtains the recording medium by payment or for free, and the first unit program is read from the recording medium thus obtained, and written in the terminal device 1. Then, upon executing the unit program, it is successively read from the terminal device 1. Of course, the unit program may be executed by directly reading from the recording medium such as the CD-ROM, etc. without writing it in the terminal device 1.

Upon completion of the first unit program, the software executor connects the terminal device 1 to the supplier server 2 by accessing the homepage of the supplier through the Internet, and gives instructs to download the succeeding unit program. At this time, the control section 3 of the supplier server 2 calls for transmission of the personal identification information and the identification information of the recording medium so as to identify the individual software executor. The personal identification information may be the address, name, sex, age, telephone number, password, ID address, E-mail address, etc. Here, the identification information of the recording medium is information such as a product serial number, etc. individually assigned to each recording medium such as a CD-ROM thus obtained. The identification information of the recording medium may be displayed on the housing case, etc. of the recording medium. Alternatively, this may be hidden from the appearance, and may be displayed on the terminal device, etc., upon operating the recording medium. Moreover, this display may be provided only once at the first time; thus, it becomes possible to strictly prevent illegal copies, etc.

Furthermore, in the case when the succeeding unit program is not a freeware, the software executor is requested to input a bank account number, prepaid card number or the like for payment.

In accordance with the request from the supplier server 2, the software executor transmits the personal identification information and identification information of the recording medium to the supplier server 2 through the terminal device 1.

Upon receipt of the information thus transmitted, the supplier server 2 first allows the built-in control section 3 to check to see whether or not the identification information of the recording medium is proper. If the identification information of the recording medium is improper, then the request for the download from the software executor is rejected.

When the identification information of the recording medium is proper, a check is made to see whether or not the personal identification information has already been registered. If the personal identification information has not been registered, then it is newly registered, and the unit program to be transmitted is selected from the unit program database 4 by the control section 3, and transmitted to the terminal device 1 of the software executor. If the personal identification information has already been registered, it is compared with the personal identification information previously registered. If the two information are not coincident, then the download request from the software executor is rejected. If the two information are coincident, then the unit program to be transmitted is selected from the unit program database 4 by the control section 3, and transmitted to the terminal device 1 of the software executor.

If downloading of the same program is permitted only once and if the personal identification information has already been registered, then further request for downloading is rejected.

Here, with respect to the identification information such as a product serial number of a recording medium such as a CD-ROM, respectively different numbers are assigned to individual recording media so that it is possible to prevent illegal copying. In other words, any identification number, once registered regularly, is then compared with the personal information of the software executor, and only when it is coincident, the download of the unit program is permitted. Therefore, even in the case when the unit program is illegally copied from the recording medium such as a CD-ROM together with the identification information of the unit program, with respect to the number that has already been registered regularly, it is compared with the personal identification information, and if it is not coincident, then the control section 3 does not permit the corresponding download. This arrangement makes it possible to prevent many other unidentified people from obtaining the next unit program by utilizing the recording medium illegally copied. Moreover, not limited to illegal copying, also in the case of re-sales or second-hand sales of software, the software distribution system of the present invention makes it possible to prevent the use of the program unless the software supplier permits it, and consequently to protect the profits of the software producer.

Moreover, there might be a case in which together with the identification information of a recording medium, the personal identification information is illegally copied. If there is such a possibility, a due date may be given to the download of the next unit program with respect to the second download request and thereafter. In other words, in this system, after a lapse of, for example, one month since the download for the first time, even if the personal identification information and the identification information of the recording medium are coincident with each other, the re-downloading operation is not permitted.

Furthermore, the unit program to be transmitted may be set so that it becomes operable only when it is coincident with the registered identification information of the recording medium; thus, it becomes possible to prevent illegal copying of the transmitted unit program.

A second embodiment of the present invention will be explained below.

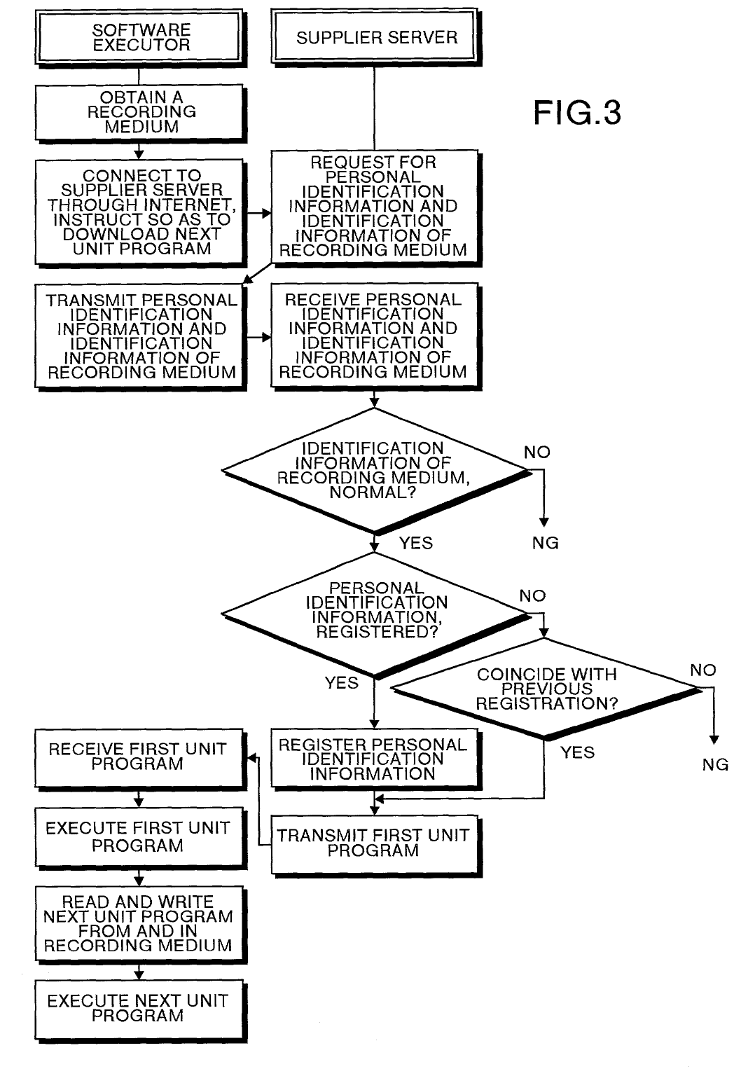

The first embodiment has exemplified a case in which a software executor obtains the first unit program by purchasing a recording medium such as a CD-ROM. Here, referring to FIG. 3, this embodiment exemplifies a case in which a software executor purchases a recording medium such as a CD-ROM that lacks the first unit program, and the succeeding unit program is provided through the network such as the Internet.

First, the software executor purchases a recording medium such as a CD-ROM storing desired software. Then, the software executor connects the terminal device 1 to the supplier server 2 by accessing the supplier's homepage through the Internet, and gives instructions so as to download the first unit program. At this time, the control section 3 of the supplier server 2 requests for transmission of the personal identification information and the identification information of the recording medium so as to identify the individual software executor. Accordingly, the software executor transmits the personal identification information and identification information of the recording medium recorded in the obtained recording medium such as a CD-ROM to the supplier server 2 through the terminal device 1.

Upon receipt of the information thus transmitted, the supplier server 2 first allows the built-in control section 3 to check to see whether or not the identification information of the recording medium is proper. If the identification information of the recording medium is improper, then the request for the download from the software executor is rejected.

When the identification information of the recording medium is authentic, a check is made to see whether or not the personal identification information has already been registered. If the personal identification information has not been registered, then it is newly registered, and the first unit program to be transmitted is selected from the unit program database 4 by the control section 3, and transmitted to the terminal device 1 of the software executor. If the personal identification information has already been registered, it is compared with the personal identification information previously registered. If the two information are not coincident, then the download request from the software executor is rejected. If it is coincident, then the unit program to be transmitted is selected from the unit program database 4 by the control section 3, and transmitted to the terminal device 1 of the software executor.

If downloading of the same program is permitted only once and if the personal identification information has already been registered, then further request for downloading is rejected.

Next, the software executor executes the first unit program thus received, and upon completion of the first unit program, executes the next unit program by writing and reading on and from the recording medium.

With this arrangement, in the same manner as the first embodiment, even in the case of illegal copying and re-sales or second-hand sales of software not permitted by the software supplier, the second embodiment makes it possible to prevent the use of the program unless the software supplier permits it, and consequently to protect the profits of the software producer.

Moreover, the unit program to be transmitted may be set so that it becomes operable only when it is coincident with the registered identification information of the recording medium; thus, it becomes possible to prevent illegal copying of the transmitted unit program.

A third embodiment of the present invention will now be explained.

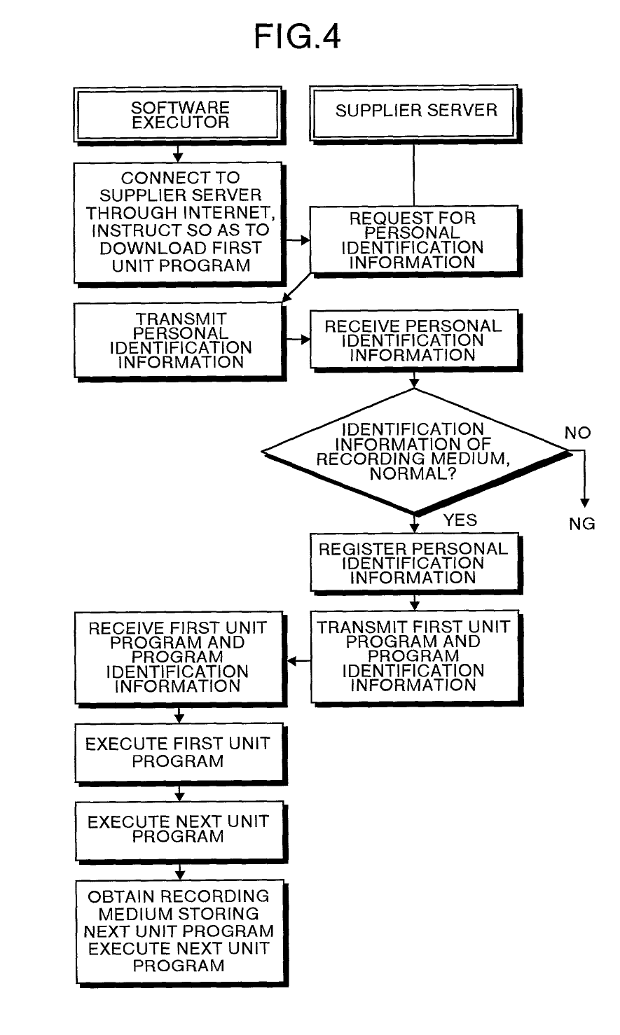

The first and second embodiments have exemplified cases in which, after having obtained a recording medium such as a CD-ROM, the software executor is allowed to obtain the succeeding unit program through a network such as the Internet. As shown in FIG. 4, the third embodiment exemplifies a case in which a software executor obtains the first unit program as a trial program through a network such as the Internet, and then obtains the succeeding unit program as a recording medium such as a CD-ROM.

First, a software executor connects the terminal device 1 to the supplier server 2 through the Internet. That is, the software executor activates the browser software on the terminal device 1 and makes contact with the supplier server 2 by accessing the supplier's homepage. Then, the software executor gives instructions so as to download desired software displayed on the homepage. Upon receipt of the instruction for the download, the supplier server 2 opens a page for requesting for the personal identification information. The software executor inputs the personal identification information to the page and transmits the resulting information. Upon receipt of the personal identification information, the supplier server 2 checks to see whether or not the transmitted personal identification information is authentic. If the information is not authentic then recognizes it as an error, or again calls for the information transmission. If the information is authentic, the supplier server 2 registers it inside the supplier server 2 or in an external separated database, and selects the first unit program that is trial software from the unit program database 4, and then transmits it to the software executor. Simultaneously, it transmits the program identification information of the first unit program. The program identification information is provided as information that is different from each other for each personal identification information, and registered in the database in which the above-mentioned personal identification information has been registered.

The software executor who has obtained the program identification information and the first unit program executes the first unit program. When the software executor likes the trial software, he or she orders a recording medium in which the next unit program is recorded to the supplier. In this case, the above-mentioned program identification information has to be presented at the same time. Here, it is possible to prevent illegal copying by setting the program identification information as follows:

(1) In a shop, etc., for the recording medium, the program identification information is presented by a customer who wishes to buy the program, and by inputting the program identification information to the recording medium in which the next unit program has been recorded, the next unit program is set so that it is not operable unless the first unit program having the same program identification information is used. For example, by making all pieces of program identification information different from each other using serial numbers, the recording medium in which the next unit program has been recorded is allowed to operate with respect to only the specific first unit program; thus, it becomes possible to prevent illegal copying.

(2) Upon receipt of the order, the supplier transmits the next unit program that has been set so as to operate only with the first unit program having the corresponding program identification information to a dedicated terminal device preliminarily set, and allows it to download the next unit program and to record it on a recording medium so that an order-made recording medium for the software executor having made the order is formed. Thereafter, the resulting recording medium is supplied to the software executor; thus, it becomes possible to prevent illegal copying.

(3) The program identification information is set to be constituted by several kinds of information, and only the next unit program having a coincided piece of program identification information is allowed to operate. In a shop, etc. for the recording medium, a customer who wishes to buy the program presents a specific piece of program identification information, and a recording medium in which the next unit program having the coincided program identification information is supplied. Supposing that four kinds of information A, B, C and D are set as program identification information, even if someone illegally copied a recording medium once obtained, and delivered it to many unidentified people, the chance of the copies being actually operable would be one-fourth; therefore, this method is effective in actually preventing illegal copies.

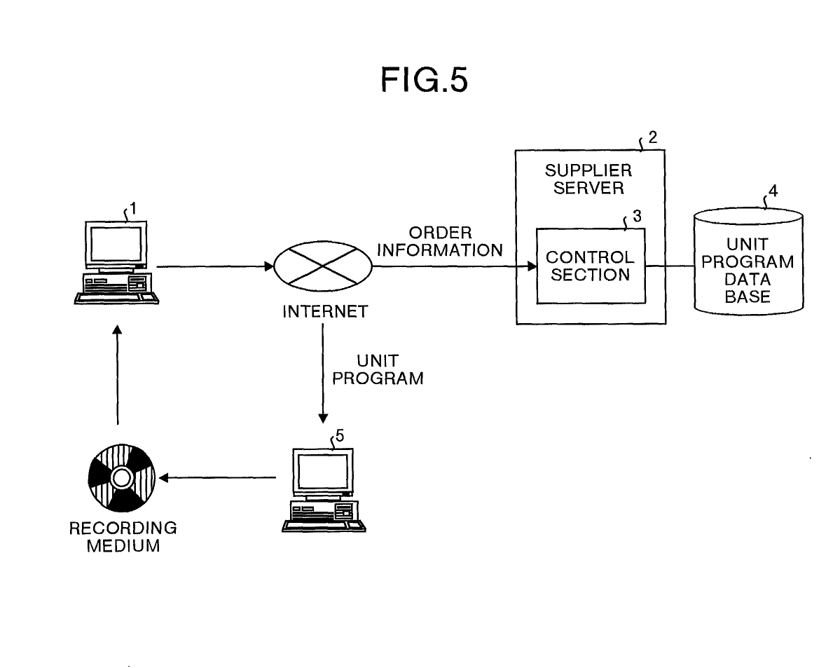

Moreover, with respect to the method for ordering the recording medium, the order may be transmitted to the supplier server 2 together with a bank account number or a pre-paid card number, etc., and the delivery may be made by mail. Alternatively, as shown in FIG. 5, the ordered next unit program may be downloaded to a dedicated terminal device 5 preliminarily set by the supplier server 2 so as to be recorded in a recording medium, and the software executor may purchase it. In this case, the dedicated terminal device 5 may be set at each of shops or convenience stores that are distributed all around the country; this makes it convenient for the software executor to purchase the program.

It is not necessary for the software executor to purchase the next unit program if, as a result of the trial, the software executor does not like it.

With respect to the systems and methods explained in the first to third embodiments, a fourth embodiment will discuss a case in which a piece of game software is delivered as an example of the actual application thereof.

First, the game software is divided into some unit programs, and the first unit program may only contain an opening scene, or a preview for introducing the flow of the entire game. Moreover, if the game is a detective game, the first unit program may contain a story from the introduction to the occurrence of any case, and the next unit program may contain a story in which the case is solved.

Moreover, in the case of a role-playing game, various selectable episodes may be provided for software executors, and only the unit program succeeding to the episode selected by each software executor may be delivered. This method eliminates the need for delivering all the unit programs succeeding to the respective selectable episodes, thereby minimizing the capacity of the recording medium to be delivered or the unit programs to be transmitted. In this case, the software needs to be divided into a considerably large number of unit programs; however, it becomes possible to provide the software executor with magnificent, well-planned role-playing games.

With respect to the systems and methods explained in the first to third embodiments, a fifth embodiment will discuss a case in which a piece of animation software is delivered as an example of the actual application thereof.

First, the animation software is divided into some unit programs, and the first unit program may only contain an opening scene or a preview for introducing the flow of the entire animation. Alternatively, only the program for reproducing animations may be delivered as the first unit program, and a piece of animation software desired by a software executor may be delivered as the next unit program.

As described above, according to the software distribution system and method of the present invention it is possible to prevent illegal copying of software and unlicensed used software sales.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A software distribution system comprising:
a database that stores at least one software divided into a plurality of unit programs;
a terminal device that is connectable to a network;
a supplier server connected to said database and which receives order information transmitted from said terminal device through said network, and which, if the order information is authentic, then selects a unit program to be sent among the unit programs stored in said database and transmits the corresponding unit program to said terminal device through said network;
a recording medium which includes at least one unit program among the unit programs, and which is distributed to an executor of the software.

2. The software distribution system according to claim 1, wherein said supplier server having a control section for executing input/output control of said network, analysis of the order information and selection of the unit program to be transmitted.

3. The software distribution system according to claim 1, wherein said recording medium contains at least a first unit program among the unit programs.

4. The software distribution system according to claim 1, wherein said recording medium contains any program among the unit programs except at least a first unit program.

5. The software distribution system according to claim 1, wherein the unit program is recorded on said recording medium by the way of transmitting the unit program from said supplier server to a dedicated terminal device and then downloading into said recording medium.

6. A software distribution method comprising the steps of:
providing software consisting of a plurality of divided unit programs;
allowing a software executor to obtain a recording medium including at least a first unit program;
allowing the software executor to transmit order information including personal identification information of the software executor and identification information of the recording medium to a supplier server from a terminal device through a network; and
if, upon receipt of the order information, the order information is authentic, then allowing the supplier server to transmit a next unit program from a unit program database to the terminal device through the network so as to be distributed to the software executor.

7. The software distribution method according to claim 6, wherein the next program is set so as to be operated only on the first unit program having the program identification information of the predetermined recording medium.

8. A software distribution method comprising the steps of:
providing software consisting of a plurality of divided unit programs;
allowing a software executor to obtain a recording medium storing the software except at least a first unit program of the software;
allowing the software executor to transmit order information including personal identification information of the software executor and identification information of the recording medium to a supplier server from a terminal device through a network; and
if, upon receipt of the order information, the order information is authentic, then allowing the supplier server to transmit the first unit program from a unit program database to the terminal device through the network so as to be distributed to the software executor.

9. A software distribution method comprising the steps of:
providing software consisting of a plurality of divided unit programs;
allowing a software executor to transmit order information including personal identification information to a supplier server from a terminal device through a network;
if, upon receipt of the order information, the order information is authentic, then allowing the supplier server to transmit a first unit program and program identification information from a unit program database to the terminal device through the network so as to be distributed to the software executor;
if the software executor desires the next unit program, allowing the software executor to transmit re-order information including personal identification information of the software executor and the program identification information to a supplier server from a terminal device through a network; and
if, upon receipt of the order information, the order information is authentic, then allowing the supplier server to distribute the next unit program in a state recorded in a recording medium.

10. The software distribution method according to claim 9, wherein the next program is set so as to be operated only on the first unit program having the predetermined program identification information.

11. The software distribution method according to claim 9, wherein, upon distribution to the software executor, the next unit program recorded in the recording medium is set so as to be operated only when coincident with the program identification information of the first unit program.

12. The software distribution method according to claim 9, wherein, upon distribution to the software executor, the next unit program recorded in the recording medium is set so as to have the program identification information that is coincident with the first unit program among a plurality of pieces of the set program identification information.

13. A software distribution system comprising:
a terminal device connectable to a network;
a server connectable to said network and selling softwares;
a database connected to said server and storing at least one software, the software being divided into a plurality of fractions; and
at least one recording medium which stores thereon a fraction or all the fractions of one or more softwares stored in said database.
wherein, when a user wishes to buy a software sold by said server he/she send order information to said server using said terminal device and said network,
said server checks the authenticity of the order information received from the user by comparing the order information with an information already stored in said server, and when said server decides that the order information is authentic it send only a fraction of the software stored in said database to said terminal device of the user through said network and sends said recording medium that records all the fractions of said software or only the fractions of said software that were not send to the user to the user using a means other that said network.
